(19) United States
(12) Patent Application Publication
(10) Pub. No.: US 2019/0303107 A1
(43) Pub. Date: Oct. 3, 2019

(54) AUTOMATED SOFTWARE PROGRAMMING GUIDANCE

(71) Applicant: CA, Inc., Islandia, NY (US)

(72) Inventor: Ian Aloysious Kelly, Colleyville, TX (US)

(73) Assignee: CA, Inc., Islandia, NY (US)

(21) Appl. No.: 15/941,533

(22) Filed: Mar. 30, 2018

(51) Int. Cl. G06F 8/33; G06F 8/34; G06N 99/00

(52) U.S. Cl. CPC G06F 8/33; G06N 99/005; G06F 8/34

(57) ABSTRACT

Lines of code entered in a source code editor graphical user interface (GUI) in a particular coding project are identified and similarities are autonomously determined between the particular coding project and a subset of coding project templates in a plurality of coding project templates based on the lines of code. The subset of coding project templates is based on a set of other coding projects, and the similarities are determined based at least in part on a correlation between the lines of code of the particular coding project and lines of code in the set of other coding projects. Code suggestions are determined, which are defined according to the subset of code templates, for lines of code following the particular lines of code. A particular GUI window is presented for display with the source code editor GUI, where the suggestions are presented within the particular GUI window.

### BACKGROUND

The present disclosure relates in general to the field of computer development, and more specifically, to computing systems monitoring source code within a source code editor to autonomously derive source code development suggestions for presentation in connection with a source code editor graphical user interface.

Modern software systems often include multiple programs or applications working together to accomplish a task or deliver a result. For instance, a first program can provide a front end with graphical user interfaces with which a user is to interact. The first program can consume services of a second program, including resources of one or more databases, or other programs or data structures. Software programs may be written in any one of a variety of programming languages, with programs consisting of software components written in source code according to one or more of these languages. Development environments exist for producing, managing and compiling these programs. For instance, an integrated development environment, or “IDE,” may be used which includes a set of integrated programming tools such as code editors, compilers, linkers, and debuggers.

### BRIEF SUMMARY

According to one aspect of the present disclosure, lines of code entered in a source code editor graphical user interface (GUI) in a particular coding project may be identified and similarities may be autonomously determined between the particular coding project and a subset of coding project templates in a plurality of coding project templates based on the lines of code, the subset of coding project templates based on a set of other coding projects. The similarities may be determined based at least in part on a correlation between the lines of code of the particular coding project and lines of code in the set of other coding projects. Code suggestions may be determined, which are defined according to the subset of code templates, for lines of code following the particular lines of code. A particular GUI window may be presented for display with the source code editor GUI, where the suggestions are presented within the particular GUI window.

### BRIEF DESCRIPTION OF THE DRAWINGS

FIG. 1 is a simplified schematic diagram of an example computing system including an example software development system in accordance with at least one embodiment;

FIG. 2 is a simplified block diagram of an example computing system including an example software development system and repository system in accordance with at least one embodiment;

FIG. 3 is a simplified block diagram illustrating an example guidance window for presentation with a source code editor window in a graphical user interface of an example software development system in accordance with at least one embodiment;

FIGS. 4A-4C are simplified block diagrams illustrating providing a guidance window in association with a source code editor in accordance with at least some embodiments;

FIG. 5 is a block diagram illustrating a portion of an example graphical user interface including a guidance window in accordance with at least some embodiments;

FIGS. 6A-6B are block diagrams illustrating a portion of an example graphical user interface including a guidance window in accordance with at least some embodiments;

FIG. 7 is a simplified block diagram illustrating generation of example coding project templates in accordance with at least some embodiments;

FIGS. 8A-8B are simplified flowcharts illustrating example techniques associated with providing a guidance window in association with a graphical user interface of an example source code editor in accordance with at least some embodiments.

Like reference numbers and designations in the various drawings indicate like elements.

### DETAILED DESCRIPTION

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely in hardware, entirely software (including firmware, resident software, micro-code, etc.) or combining software and hardware implementations that may all generally be referred to herein as a “circuit,” “ module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, CII, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

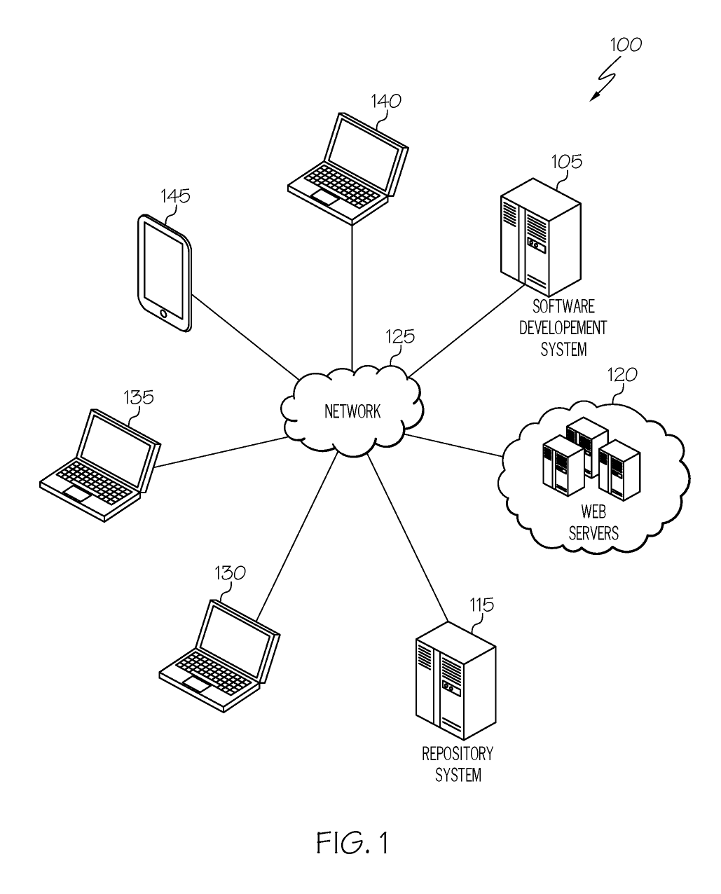

Referring now to FIG. 1, a simplified block diagram is shown illustrating an example computing environment 100 including an example software development system 105, which may host an integrated development environment (IDE) including a source code editor to allow user-developers to draft code to implement various software programs. In some implementations, the software development system 105 may be equipped with enhanced logic, implemented in hardware and/or software, to autonomously mine code and metadata of other software coding projects to intelligently provide project-specific guidance to the developer to assist them in understanding opportunities to improve their code and resulting projects.

In some implementations, an example system 100 may further include repository systems (e.g., 115), such as a software configuration management (SCM) repository system. Repository systems may include repositories which are public, such that the repositories provide open source or shared software components together with management of changes within these components. An example repository system (e.g., 115) may also host and manage private repositories, such as an enterprise repository system or repository for a particular software development firm (e.g., to balance the privacy of the code being developed by such an enterprise (which may be of extreme importance) with developer collaboration within the enterprise through the repository system). In some implementations, the repositories hosted by an example repository system 115 may include a wealth of other coding projects and related metadata, which may be used by an example software development system 105 to guide the development of new coding projects and modification of existing coding projects, among other example uses. For instance, data from other coding projects may be used to determine patterns among groups of coding projects. These patterns may be used to generate suggested outlines for new coding projects. Information from other coding projects may also be leveraged to autonomously customize source code samples (e.g., provided by third party sources (e.g., web servers 120)) to a particular project being editing using an example IDE (e.g., provided by software development system 105), among other examples. In some instances, the software development system (e.g., 105) may be combined with a repository system (e.g., 115) such that the software development system interface directly with the repository system (e.g., in support of enhanced software development functionality provided through the software development system) and provide source code editing tools in connection with repositories of the repository system, among other example implementations.

An example system may further include a variety of other server systems (e.g., 120) hosting various resources that may be accessed and consumed using other computing systems (e.g., 105, 115, 130, 135, 140, 145, etc.). For instance, web servers 120 may be embodied as various computing systems connected to one or more networks (e.g., 125), which may host various applications, web pages, services, data, and other resources. In some cases, web servers 120 may host blogs, online training materials, and other web pages, which may include source code examples and other information that developer-users may access to educate and guide them in their respective coding projects, peer reviews, etc. Developer-users (or simply “users” or “developers”) may utilize various user devices (e.g., 130, 135, 140, 145) to connect to one or more networks (e.g., 125) and access resources hosted by various server systems (e.g., 120). Indeed, user devices (e.g., 130, 135, 140, 145) may be additionally used to access data, services, and resources including those hosted by example enhanced software development systems (e.g., 105, example repository systems (e.g., 115), among other examples. In some instances, the user devices (e.g., 130, 135, 140, 145) may also be used to provide data to remote services and systems (e.g., over networks (e.g., 125)). For instance, client devices (e.g., 130, 135, 140, 145) may also interface with repository systems (e.g., 110, 115) to provide various source code components (e.g., projects, applications, branches, etc.) for inclusion or updates to repositories hosted by the repository systems, among other examples. In some cases, a web browser or other platform provided on a user device (e.g., 130, 135, 140, 145) may be used to interface with, execute, or otherwise use resources provided by other systems (e.g., 105, 115, 120) communicatively coupled to the user devices over one or more networks (e.g., 125). Networks (e.g., 125) within the system 100 may include private and/or public networks including wireless and/or wireline networks facilitated using various network technologies and topologies.

In general, “servers,” “clients,” “computing devices,” “network elements,” “database systems,” “user devices,” and “systems,” etc. (e.g., 105, 115, 120, 130, 135, 140, 145, etc.) in example computing environment 100, can include electronic computing devices operable to receive, transmit, process, store, or manage data and information associated with the computing environment 100. As used in this document, the term “data processing apparatus,” “computer,” “processor,” “processor device,” or “processing device” is intended to encompass any suitable processing device. For example, elements shown as single devices within the computing environment 100 may be implemented using a plurality of computing devices and processors, such as server pools including multiple server computers. Further, any, all, or some of the computing devices may be adapted to execute any operating system, including Linux, UNIX, Microsoft Windows, Apple OS, Apple iOS, Google Android, Windows Server, etc., as well as virtual machines adapted to virtualize execution of a particular operating system, including customized and proprietary operating systems.

Further, servers, clients, network elements, systems, and computing devices (e.g., 105, 115, 120, 130, 135, 140, 145, etc.) can each include one or more processors, computer-readable memory, and one or more interfaces, among other features and hardware. Servers can include any suitable software component or module, or computing device(s) capable of hosting and/or serving software applications and services, including distributed, enterprise, or cloud-based software applications, data, and services. For instance, in some implementations, an enhanced software development system 105, repository systems (e.g., 115), web server systems (e.g., 120), or other sub-system of computing environment 100 can be at least partially (or wholly) cloud-implemented, web-based, or distributed to remotely host, serve, or otherwise manage data, software services and applications interfacing, coordinating with, dependent on, or used by other services and devices in environment 100. In some instances, a server, system, subsystem, or computing device can be implemented as some combination of devices that can be hosted on a common computing system, server, server pool, or cloud computing environment and share computing resources, including shared memory, processors, and interfaces.

While FIG. 1 is described as containing or being associated with a plurality of elements, not all elements illustrated within computing environment 100 of FIG. 1 may be utilized in each alternative implementation of the present disclosure. Additionally, one or more of the elements described in connection with the examples of FIG. 1 may be located external to computing environment 100, while in other instances, certain elements may be included within or as a portion of one or more of the other described elements, as well as other elements not described in the illustrated implementation. Further, certain elements illustrated in FIG. 1 may be combined with other components, as well as used for alternative or additional purposes in addition to those purposes described herein.

Modern software development may involve the cooperation of a team of developers working on respective portions of a larger software system. Further, it is becoming increasingly common for developers to rely on code components found in shared code libraries and include these components within their own projects and applications to provide objects, methods, functions, etc. for use in their projects without having to develop analogous components with similar functionality. Given these and other example trends, it is becoming increasingly difficult for individual developers and even teams of developers to understand the complex interconnections and underlying code within their own projects. Further, it is becoming increasingly common for users to rely on, include, or take inspiration from pieces of codes and related projects authored by others and of which the user has little familiarity. In such cases, developers may underappreciate the potential consequences and risks associated with relying on or using code and information provided by other users and entities, among other example issues.

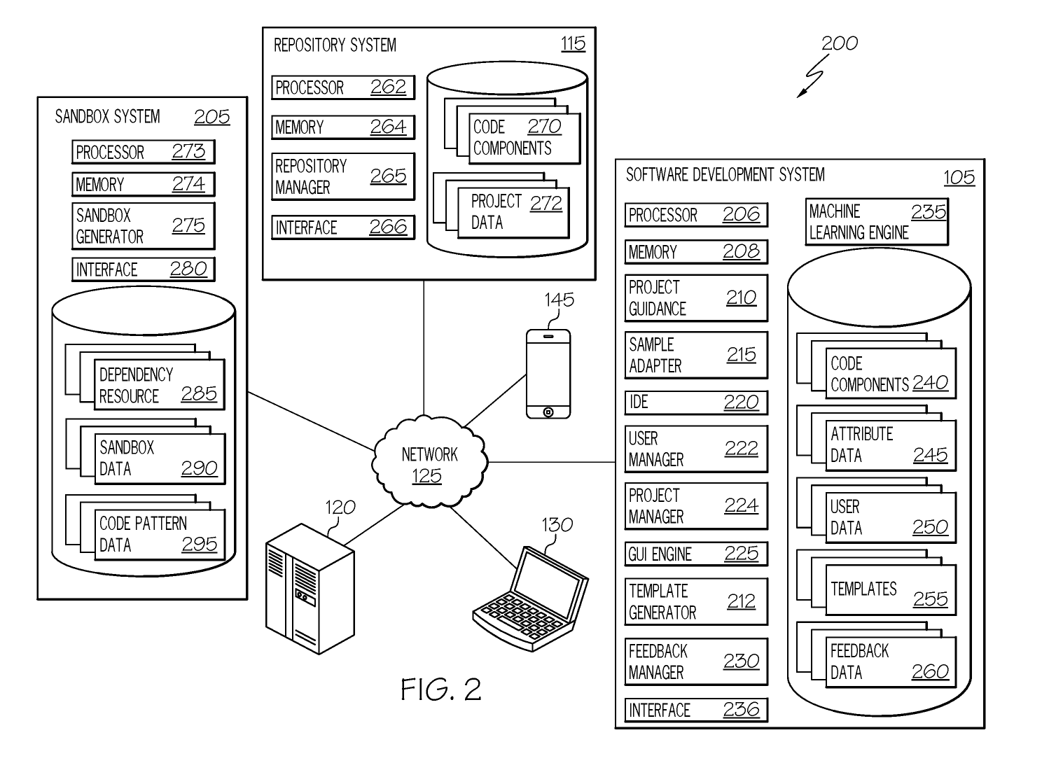

At least some of the systems described in the present disclosure, such as the systems of FIGS. 1 and 2, can include functionality to at least partially address at least some of the above-discussed issues, as well as others not explicitly described. For instance, a simplified block diagram 200 is shown illustrating an example environment including an enhanced implementation of an example software development system 105. The environment may additionally include repository system (e.g., 115), one or more web servers, sandbox system (e.g., 205), among other example systems. An example software development system 105 may include one or more data processing apparatus (e.g., 206) and one or more memory elements (e.g., 208) for use in implementing executable modules, such as a project guidance engine 210, coding template generator 212, a code sample adapter 215, integrated development environment (IDE) 220, a user or account manager 222, project manager 224, graphical user interface (GUI) engine 225, user feedback manager 230, among other example components. In some implementations, an enhanced software development system 105 may include or have access to one or more machine learning engines (e.g., 235) (which may include specialized machine learning hardware, such as a tensor processing unit, matrix processing unit, specialized graphics processing unit, among other examples), which may be utilized to perform various machine learning algorithms, using example machine learning models (e.g., neural network models, random forest models, support vector machine (SVM) models, etc.) in connection with and/or to enable functionality of one or more of the components (e.g., 210, 212, 215, 230, etc.) of the enhanced software development system 105, among other examples.

Components of an enhanced software development system 105 may be used to enhance the core software development functionality and tools of the system 105. For instance, core software development functionality may be facilitated through an IDE 220. The IDE 220 may provide functionality such as would be included in a traditional IDE. For instance, the IDE 205 may include a source code editor, build automation tools, a debugger, etc. and may include functionality such as code completion, object and class browsers, syntax highlighting and guides, among other example features. A graphical user interface (GUI) engine 225 may be provided to provide GUIs in connection with the IDE (e.g., a source code editor GUI) as well as other components (e.g., project guidance engine 210) of the software development system. Some components may interface with and track activity of various GUIs offered through the software development system (e.g., using GUI engine 225), so as to identify a project, code component, user behaviors, and other information pertaining to the present context of the software development system's use by a user. Such functionality and information may be leveraged to autonomously provide assistance to the user in improving and completing coding projects using the enhanced software development system (e.g., 105), among other example features and benefits.

In one example implementation, an example enhanced software system 105 may include a project guidance engine 210. In one example, a project guidance engine 210 may include logic, implemented in hardware circuitry (e.g., logic circuits) and/or software, to provide content to a GUI window for display with a source code editor GUI window of the software development system 105. More particularly, the project guidance engine 210 may provide suggestions, for display within the GUI window, that are specifically and dynamically adapted to the code entered by particular user within the source code editor GUI for a particular coding project (e.g., an application or part of an application, code module, or other component of source code developed using the software development system 105). Accordingly, the project guidance engine 210 may track and continuously analyze code as it is modified within a project using the software development system 105 and determine similarities between the code, as it is entered, with one or more coding project templates 255, which may define a pattern of code within particular categories of projects. The various categories of the projects may be defined based on commonalities identified within groups of coding projects (e.g., within code components 240, 270), for instance, by a template generator 212. The template generator 212 may identify coding patterns within these groupings of similar code and generate respective coding project templates 255 based on these patterns. The coding project templates 255 may describe or outline these patterns and may identify the progression of code within these categories of code, for instance, as a set of steps, as pseudocode (e.g., to capture that the categories of code, although potentially written in different programming languages, may be structurally and functionally similar), and/or actual code examples. The templates 255 may thus provide information to guide developers as they write code in projects similar to these categories of project. Indeed, the project guidance engine 210 may identify a probability that the code in a particular project is similar to and corresponds to a certain category of coding projects, and may further identify the current progress of the user in developing this particular project to provide suggestions for the next line or lines of code based on a corresponding template. This suggestion information may be presented within the GUI window presented with the source code editor do as to provide the developer with an intelligence guide during coding, among other example features.

An enhanced software development system 105 may additionally include a code sample adapter 215 to further (or alternatively) assist users as they develop code within a particular coding project. For instance, a code sample adapter 215 may monitor code being edited using an example IDE 220 of the software development system 105 (e.g., edited in a corresponding source code editor) and may likewise obtain information regarding the user (e.g., from user data 250 generated and managed by user manager 222) and additional project-related metadata (e.g., encapsulated in project attribute data and other data, such as managed and generated by a project manager engine 224) to autonomously determine the current project being worked on by the user and the more generalized preferences of the user. The code sample adapter 215 may, at the same time, also monitor web pages and electronic documents accessed by the user contemporaneously with (e.g., at or near (i.e., before or after) the time of the) user's use of a source code editor to edit a particular project to autonomously determine the likely context of the user's access and perusal of these web pages or other electronic documents (e.g., word processor files, Portable Document Format (PDF) documents, etc.). The code sample adapter 215 may scan these electronic documents as they are accessed by the user to detect whether the electronic document includes code samples, such as example code offered by an author of the document to demonstrate how certain functionality may be implemented within the particular coding project using source code). The code sample adapter 215 may identify one or more values within the code (e.g., based on analysis and mining of other code components (e.g., 240, 270)) that tend to vary on a project- or system-specific basis, or based on certain tendencies or preferences of the user implementing similar code. Accordingly, the code sample adapter 215 may autonomously identify, from the determined context of the user's access of this document, substitute values based on project attribute data 245, user data 250, and other information accessible by the code sample adapter 215 describing attributes of the user's project. The code sample adapter 215 may then cause the identified values to be masked or replaced by the substitute values during presentation of the electronic document to the user. In this manner, the code samples within the document may be adapted specifically, and dynamically, to the user's own project, making the samples more relevant, understandable, and easier to implement within the user's own code, among other example benefits.

Components within an example software development system 105 may autonomously predict what information and content (e.g., guidance suggestions generated by a project guidance engine 210 or adapted code samples generated by a code sample adapter 215) is relevant to a particular user based on the code they enter in connection with a particular coding project. In some cases, these predictions, and the resulting data delivered by these components (e.g., 210, 215) may be flawed and of diminished relevance. In some cases, components may accept human supervision to tune their autonomous functionality. For instance, user feedback may be provided in connection with suggestions or customized code samples. The components may then analyze and consider this feedback (e.g., as collected and managed using a feedback manager component 230 and feedback data 260) in future predictions performed by the components (e.g., 210, 212, 215) to make the components progressively more accurate. In some cases, components may be built upon machine learning models, which may include supervised learning models and training sets, which may be supplemented by feedback data 260, among other example uses.

An example software development system 105 may include one or more interfaces (e.g., 236), such as application programming interfaces (APIs) and other interfaces to communicate data between the software development system 105 and one or more other systems (e.g., repository system 115, sandbox system 205, etc.). It should be appreciated that the example software development system 105 illustrated in FIG. 2 may, in other alternative embodiments, be implemented as multiple, distinct systems to provide various sub-combinations of the components shown in the example of FIG. 105. For instance, a template generator 212, in some implementations, may be provided through a separate system, which interfaces with a software development system through one or more APIs (e.g, 236), among other examples (such as examples where a project guidance engine 210 and code sample adapter 215 are provided in separate systems).

In one example, an example sandbox system 205 may be provided, for instance, to supplement functionality and services provided through an example code sample adapter 215. Indeed, in some implementations, a code sample adapter 215 may be provided together with a sandbox system (e.g., in the same or otherwise related systems). In one example, a sandbox system may include one or more data processing apparatus (e.g., 273) and one or more memory elements (e.g., 274) for use in implementing executable modules, such as a sandbox generator 275. The sandbox system 205 may additionally include other components, such as an interface (e.g., 280) to communicate and provide and consumer resources with other systems (e.g., a software development system 105 and repository system 115), among other example components and functionality. In one example, a sandbox generator 275 may be utilized to generate a sandbox execution environment in which a code sample (e.g., selected by a user for sandboxing in connection with presentation of the code sample to the user in a corresponding electronic document) may be executed. For instance, a request to execute a code sample presented in an electronic document, including samples modified by a code sample adapter 215 to reflect project-specific values (e.g., syntax, language, variable values, etc.), may be received by the sandbox generator 275. The sandbox generator 275 may access information (e.g., code pattern data 290) relating to similar uses of similar code within other coding projects to determine a set of dependencies that are to be included within a system in order to successfully execute the code. For instance, a pattern may be determined in code pattern data 295 showing that the use of segments of code similar to the sample code appear to be predicated on the presence of various dependencies (e.g., other software and/or hardware resources, such as a server platform, database, other objects or methods, pre-defined variables, etc.). The sandbox generator 275 (or another supporting component, such as a component of a corresponding software development system (e.g., 105)) may autonomously determine the set of dependencies corresponding to successful execution of the sample code. The sandbox system 205 may provide or obtain dependency resources 285, which the sandbox generator 275 may use to implement a sandbox environment that includes an identified set of dependencies. For instance, the sandbox generator 275 may autonomously prepare and instantiate a sandbox execution environment with the determined set of dependencies (e.g., selected from dependency resources 285). The sample code may then be run within the sandbox execution environment to allow a user to safely test and observe execution of the sample code in order to better understand whether to include the sample within the user's own project, among other example benefits. In some cases, a sandbox system 205 may save configurations of previously generated sandbox environments (e.g., as sandbox data 290) for later use (e.g., to reuse to run the same sample at another instance or to use as basis for generating other sandbox environments), among other examples

Information concerning other coding projects may be obtained, at least partially, from outside systems. In some cases, repository systems (e.g., 115) may be accessed in order to obtain information regarding other coding projects in order to guide a user's development of a particular coding project (e.g., using software development system 105). In some implementations, a repository system 115 may be combined with and enhanced by functionality provided through other systems, such as the example software development system 105 and sandbox system 205 shown and discussed in the example of FIG. 2. In some implementations, an example repository system (e.g., 115) may include one or more data processing apparatus (e.g., 262) and one or more memory elements (e.g., 264) for use in implementing executable modules, such as repository manager 265, and other examples. An example repository manager 265 may possess functionality to define and maintain repositories to track the development and changes to various code segments or components. For instance, a repository may be developed for each of several projects, with copies of the project code being stored together with modified versions of the code and other information to track changes, including proposed, rejected, accepted, and rolled-back changes to the project. In the example shown in FIG. 2, such project change information can be embodied in project data 272 along with other information (e.g., information describing the type of the project, the authors of the project, progress of the project, etc.) collected and generated by the repository manager 265 in connection with its management of the development and implementation of various code components 270 managed using repositories hosted by the repository system 115.

In some implementations, an example repository system (e.g., 115) may enable social collaboration between developers using the repository system 115. For instance, as changes to a project (or source code component) are made, they may be proposed for adoption. This may trigger a workflow, managed by the repository system 115 where other users provide feedback regarding the proposed change. Accordingly, such user feedback and commentary may be generated to document the thoughts, feedback, and commentary of various users relating to particular code components, as well as the rejection, adoption, or rollback of changes in various code component projects. Such information may be accessed and used (e.g., by project guidance engine 210, template generator 212, sample adapter 215, sandbox generator 275, etc.) to determine attributes and similarities between code components. For instance, natural language processing may be used to interpret the information (in project data 272) and determine functionality, the intended purposes, and other attributes of various code components, among other examples.

It should be appreciated that the example system configuration(s) illustrated in FIG. 2 are but one example implementation. Various other alternative designs may be adopted without deviating from the general principles discussed herein. As examples, in some implementations, two or more (or all) of software development system 105, repository system 115, and sandbox system 205 may be implemented in a single system, combining and integrating the functionality of each within a single system. Logical and functional blocks discussed as being implemented in a particular one of the example software development system 105, repository system 115, or sandbox system 205 may be alternatively implemented in another one of the systems. Likewise, example data illustrated as managed in one system may be alternatively maintained and generated in another one of the example systems. As an example, templates (e.g., 255), dependency resources (e.g., 285), source code sample documents, and other data may be maintained in other systems rather than or in addition to the systems illustrated in the example of FIG. 2, among other example alternatives and implementations.

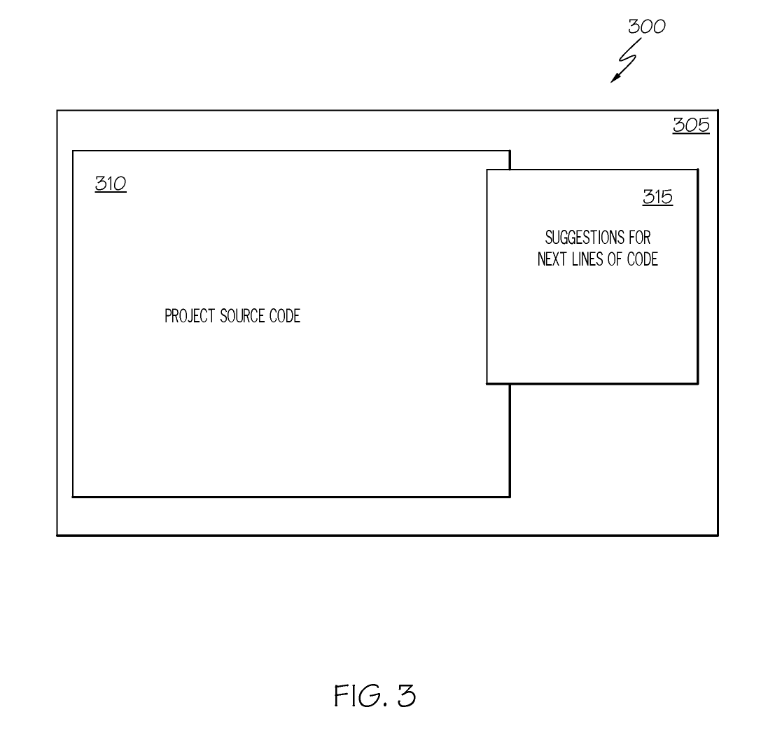

Turning to the example of FIG. 3, a simplified block diagram 300 is shown illustrating an example layout for a GUI 305 of an example software development system. In this example the GUI 305 may include a source code editor window 310, which provides a GUI for a source code editor of the software development system. Within the source code editor window 310, a user may draft and edit source code for a particular software coding project (e.g., the development of a particular application, script, object, program, or other software component). In some implementations, an additional guidance window 315 may be provided to be co-presented with (or in) the source code editor window 310. The guidance window 315 may be provided to present coding suggestions generated and provided using an example project guidance engine. The guidance window 315 may be located so as to effectively be in the user's periphery as the user codes in the source code editor window 310. As the user enters code in the source code editor window 310, an example project guidance engine may dynamically determine (e.g., from one or more templates) recommendations for next coding steps or lines of code to follow the work already completed by the user (in the source code editor window 310). Accordingly, as work progresses within the source code editor window 310, the information presented in the guidance window 315 may also be updated. In some cases, visual queues, such as the scrolling or highlighting of text within the guidance window 315, a graphical flash effect or color change, or other graphical effects may be presented to notify a user (who is likely concentrating their focus within the source code editor window 310) that new information has been provided or is being emphasized within the presentation of the guidance window, which may be a benefit to the user in determining how best to design and implement subsequent code within the project.

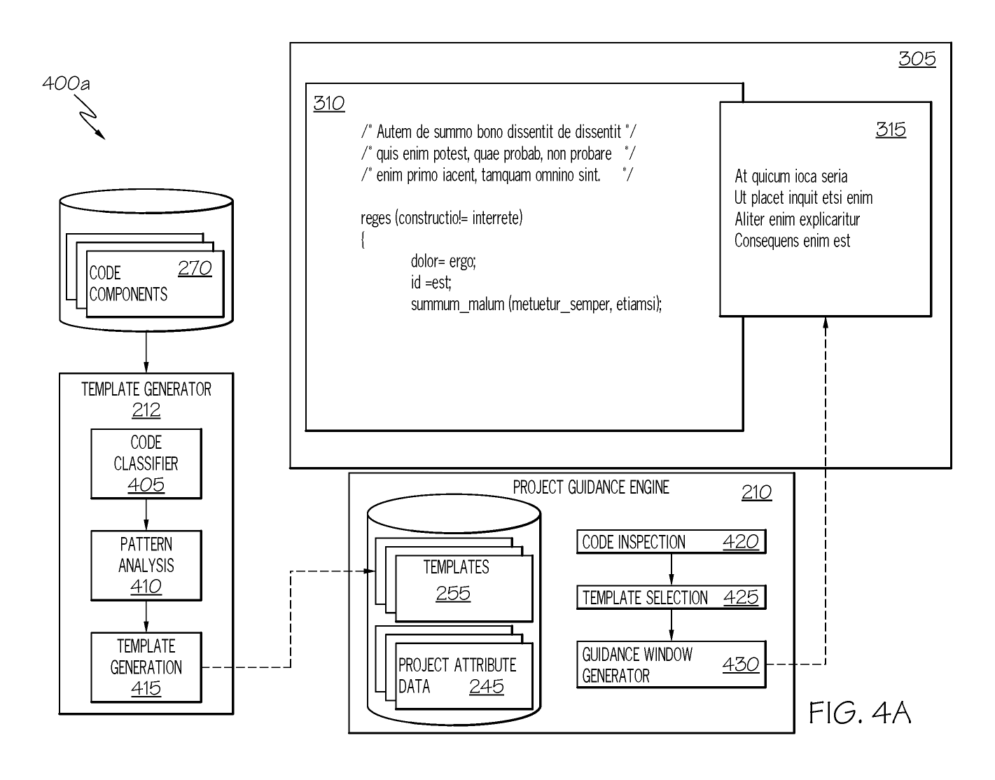

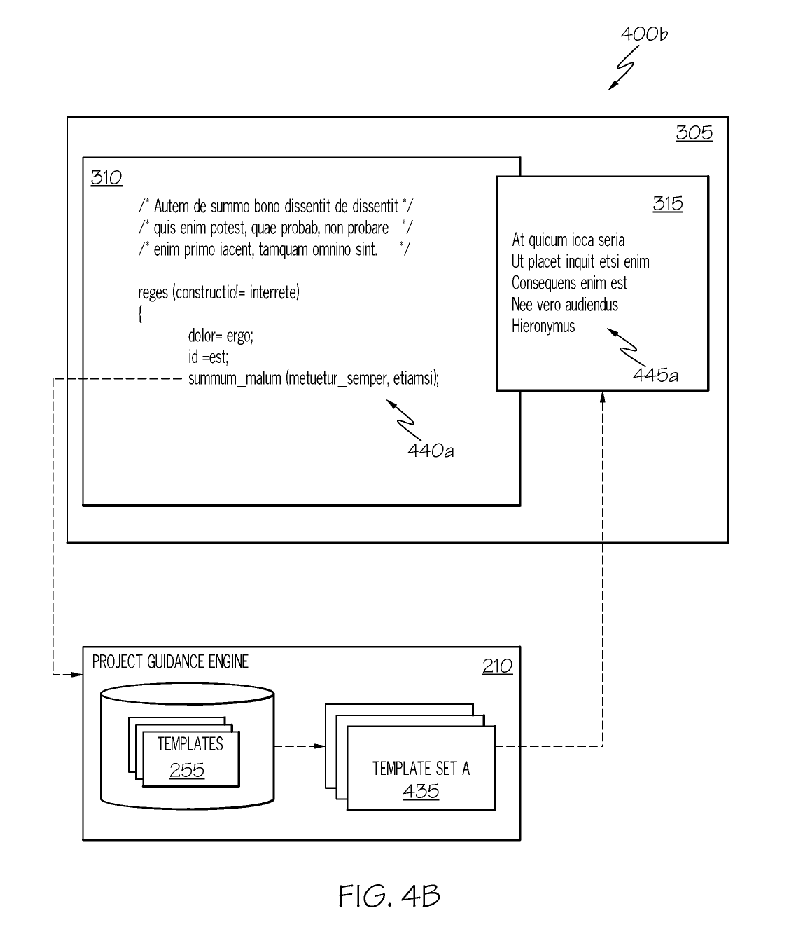

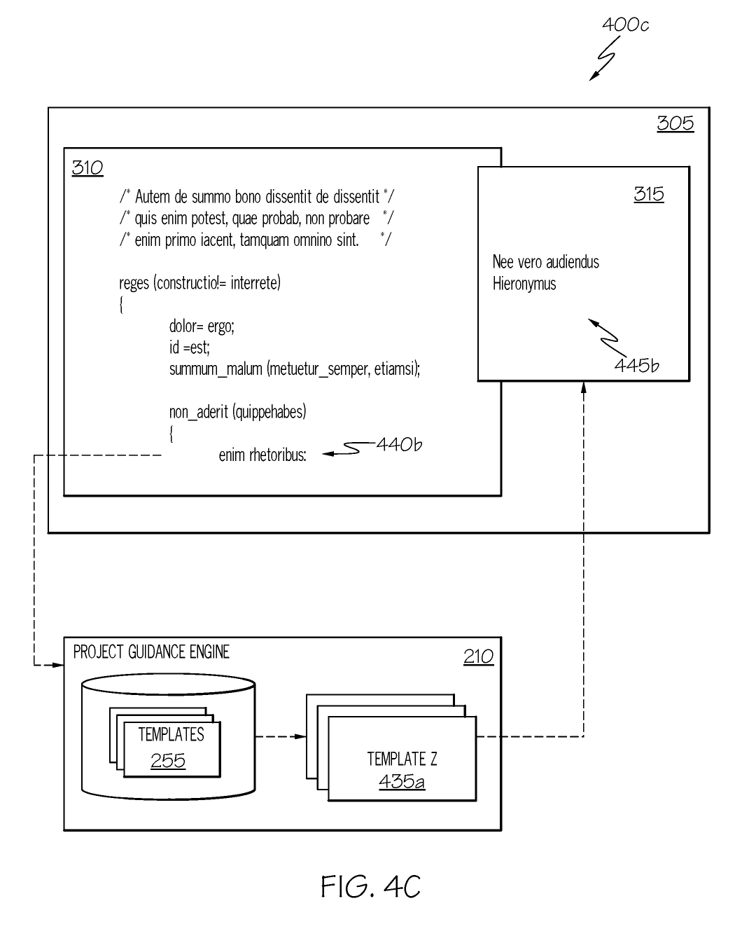

Turning to the examples of FIGS. 4A-4C, simplified block diagrams 400a-c are shown illustrating the use of an example project guidance engine 210 to autonomously and dynamically provide suggestion information in a guidance window 315 supplementing and guiding use of a source code editor (corresponding to source code editor window 310). For instance, in the example of FIG. 4A, an example project guidance engine 210 may include functionality to continuously inspect code (and other inputs) provided by a user during development of a particular coding project. For instance, code inspection 420 may be used to detect syntax, instructions, comments, and functionality of code as it is entered by a user through a source code editor window 310. The code inspection 420 of the project guidance engine 210 may identify such attributes from the code itself and compare these identified attributes (even the lines of code themselves) against attributes of other known coding projects to determine that the code entered in the source code editor window 310 resembles code or functionality of a subset of these known coding projects. In some implementations, code progression templates (or simply “templates”) may be defined for types of coding projects or code segments (within the coding projects) as has been observed within a corpus of other code components (e.g., 270). Accordingly, based on the attributes identified by the project guidance engine 210 within the code in source code editor window 310, template selection 425 may be performed by the project guidance engine 210 to identify a subset of the available templates, which corresponds to the observed attributes of the code in source code editor window 310. In some implementations, one or more machine learning algorithms and supporting models (e.g., neural networks, decision trees, SVMs, etc.) may be used (and executed using specialized system hardware) to determine that code within the source code editor window 310 or determined attributes of the code should be classified as a particular type of code or part of a larger coding project corresponding to one more of the available templates (e.g., 255). In some the code itself may be provided as an input to the model, from which a classification (e.g., of the code's or project's type) is derived. In some cases, as more code is provided within the source code editor window 310, the certainty and accuracy of the template selection 425 may increase. For instance, when only a small number of lines of code have been entered within a project, potentially numerous templates (e.g., 255) may be identified as potential matches. As additional lines of code are entered into the source code editor window 310 and inspected (at 420), classification of the code may be determined with a higher level of confidence, resulting in potentially more useful suggestions derived using a corresponding template determined to correlate with the code. In other cases, no templates may be identified as potential matches, either due to too few lines of code in the source code editor window 310 or due all available templates being ruled out based on the lines of code which have been entered, among other examples.

In some implementations, template selection 425 may also reference additional metadata available for the project currently being developed using the source code editor window 310 (e.g., as defined in project attribute data 245) to select one or more templates for use by the project guidance engine. Project attribute data 245 may include such information as the team, business unit, or user responsible for the immediate project, may detect APIs or platforms used or designated within the project, other software components with which the code or project under development is to interface and interoperate with, among other attributes. Such attributes may be used in combination with the attributes detected within the code itself (during code inspection 420) to select one or more templates for inclusion in the subset of templates selected during template selection.

The project guidance engine 210 may access selected templates and derive one or more suggestions from the templates for subsequent lines of code. These suggestions may be embodied by suggested lines of code (e.g., presented as precise coding examples in a particular programming language, as language-neutral pseudocode, or other examples) or more generalized coding suggestions (e.g., descriptions of the next coding steps or code structures (e.g., functions, calls, variables, loops, etc.), which would ordinarily follow in projects of a corresponding type), among other examples. A guidance window generator 430 within the project guidance engine 210 may then provide data for rendering a guidance window 315 to present the determined suggestion with a source code editor window 310 of a software programming system GUI 305.

Continuing with the example of FIG. 4A, templates (e.g., 255) utilized by a project guidance engine 210 to generate coding suggestions within an example guidance window 315 of a GUI 305 may be generated automatically using a computer-implemented template generator 212. For instance, a template generator 212 may have access to a corpus of code components 270 from a variety of sources, developers, and projects, including code components in a variety of different programming languages. The template generator 212 may progressively assess code components (e.g., as they become available for access (e.g., through submission or inclusion in a repository)) to classify the code components 270. This may result in types, categories, or groupings of code components or coding projects being autonomously determined and defined using the template generator 212. In some implementations, machine learning algorithm-based classification engines may be used to perform code classification (e.g., 405), among other example implementations. The groupings of similar code components determined through code classification 405 may then be assessed (at 410) to determine patterns within their respective code. Machine learning algorithms and other computer-implemented pattern recognition techniques may be used to detect patterns, such as similar code structures, ordering of code, method calls, etc. An outline of these common code features may be derived based on the pattern and corresponding templates may be generated (at 415), which describe these common code features occurring within code of a corresponding determined code classifier. The resulting templates (e.g., 255) may be provided for use by one or more project guidance engines (e.g., 210). In some cases, each template 255 may be provided with information (e.g., describing a corresponding code classification, common attributes of the template, sample code of the code classification, among other information), which may be used as a reference by the project guidance engine (e.g., during template selection) to assist the project guidance engine in matching templates to code inspected by the project guidance engine within an example source code editor window (e.g., 310), among other example features.

Turning to FIG. 4B, a project guidance engine 210 may continuously monitor and scan code entered by a developer within a source code editor window 310 to observe evolution of a particular coding project under development. As additional code is entered or existing code is modified using the source code editor window 310, the project guidance engine 210 may identify these changes and adjust the templates identified as potentially corresponding to the particular coding project and used by the project guidance engine 210 to generate suggestion information presentation within a corresponding guidance window 315. For instance, the project guidance engine 210 may detect an amount of code (e.g., 440a) entered within the source code editor window 310 and may determine that the entered amount of code 440a potentially corresponds to any one of multiple different classifications of other coding projects modeled and described using corresponding templates (e.g., 435). Accordingly, the project guidance engine 210 may select a subset of templates 435 from a corpus of available templates 255. In some cases, the project guidance engine 210 may derive sand present suggestion information within the guidance window 315 based on a particular one (or all) of the identified templates. For instance, in some implementations, project guidance engine 210 may score various other code components (and corresponding templates) based on their relative similarity to the entered code 440a. In some instances, the project guidance engine 210 may select one (or some other subset) of templates from the set 435 to use in generating suggestion information for the guidance window, based on the respective scores determined for the templates. For instance, the set of templates 435 may be selected based on each of the templates in the set 435 having a similarity score (to the entered code 440a) exceeding a particular threshold. In some cases, only the top scoring template(s) may be selected and used to generate suggestion information 440a for the guidance window 315, among other examples. For instance, suggestion information (e.g., 440) may be provided together within the guidance window for each one of the templates in a selected set 435, with the suggestion information from the different templates in the set 435 presented as alternative suggestions for potential adoption by a user, among other example implementations.

Turning to the example of FIG. 4C, as noted above, a project guidance engine 210 may dynamically adapt code suggestion information as a developer modifies code using an example source code editor window 315. For instance, in the example of FIG. 4C, a developer has added code to the lines of code (e.g., 440a) used in FIG. 4B to generate suggestion information 445a, to produce an updated code segment 445b including the code 440a. Based on the additional code added by the developer, the project guidance engine 210 may renew its analysis of the code (e.g. 440b) to determine whether the same or different templates (used in the example of FIG. 4A) are still applicable to the code 440b. Changes to code within the source code editor may result in the project guidance engine 210 determining that one or more of the templates in template set 435 (selected for use based on code 440a) should no longer be considered in determining suggestion information for the project and/or that one or more additional templates should be used that were not previously considered relevant (e.g., prior to the additional code being added to the code segment 440b). In the particular example of FIG. 4C, the additional code provided in code segment 440b may be scanned by the project guidance engine 210 to cause the project guidance engine 210 to determine that at least some of the templates determined for code 440a are no longer relevant to the further-developed version of the code 440b. Indeed, the project guidance engine 210 may determine that only a single template (e.g., 435a) is still relevant based on inspection and revised classification of the codes segment 440b. In some instances, this single template 435a may be one of those used in template set 435 (e.g., in the example of FIG. 4B), on other cases, the template 435a may be a newly identified template not included in a previously used set of templates (e.g., 435), among other examples.

As shown in FIG. 4C, changing the set of templates used by the project guidance engine 210 to determine suggestion information (e.g., 445b) for presentation in an example guidance window 315 can result in different suggestion information being presented (e.g., so as to dynamically adjust the information from what was presented in the guidance window 315 (e.g., in FIG. 4B) prior to the code being edited using source code editor window 310. In some cases, this may result in less or more information being presented in the guidance window 315. In some cases, changing (e.g., narrowing) the set of templates used may result in a change to the granularity of information presented in the guidance window 315. As an example, where multiple alternative templates are used, representing multiple alternative types of projects to which the code under development may correspond, multiple alternative suggestions may be presented within the guidance window 315. As a smaller number of templates are used to generate the suggestions information (or even a single template), a larger amount of suggestion information corresponding to each of the considered templates may be presented within the guidance window 315. For instance, suggestions may be presented for not only the next coding step or line of code, but for multiple subsequent steps or lines in the code, among other examples.

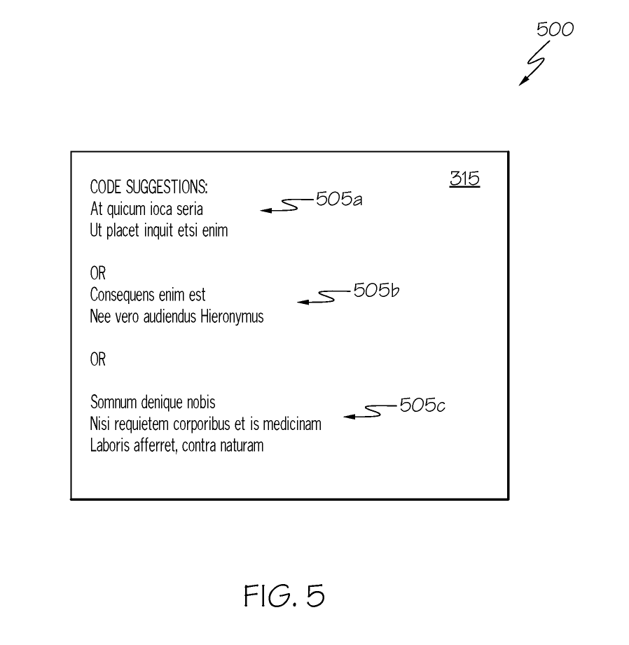

Turning to FIG. 5, a simplified block diagram 500 is shown illustrating a portion of a graphical user interface of an enhanced software development system. The GUI may include a guidance window presenting suggestion information generated and formatted according to one or more underlying templates determined, by a project guidance engine 310, to be relevant to code entered into a corresponding source code editor. As noted above, in some cases, multiple templates may be identified as corresponding to a given amount of code. In such instances, the project guidance engine 310 may generate portions of suggestion information from two or more of the multiple templates. In some implementations, when different suggestion information is determined as potentially applying to next lines of code within a particular project under development, each of these multiple suggestions may be presented together within the same guidance window 315, but formatted to indicate that the suggestion information is presented in the alternative (implying that the suggestions correspond to distinct, and potentially contradictory coding project types).

As an example, in FIG. 5, multiple code suggestions 505a-c corresponding to multiple different templates, may be presented within guidance window 315. In some examples, additional information may be generated and presented with each code suggestion to indicate a corresponding template or a type of coding project type to which the code suggestion (e.g., 505a-c) pertains. A developer may view the alternative code suggestions 505a-c presented within the guidance window while coding their own project (within a corresponding source code editor) and assess whether one (or any) of the presented code suggestions is more relevant or helpful that the others. The project guidance system may monitor how a user responds the presented code suggestions 505a-c (e.g., through interactions with guidance window or the source code editor window) to determine which suggestion(s) were of most relevance. The project guidance engine may take into account this user feedback information when generating and presenting subsequent code suggestions either within this same project or other projects associated with the user providing the feedback. For instance, the guidance window 315 may further provide GUI elements, such as voting buttons, to allow a user to provide feedback indicating how and/or what degree to which each alternative code suggestion 505a-c is relevant or useful to a given project under development. In other cases, such feedback may be provided more implicitly. For instance, a user may copy a particular one of the code suggestions 505a-c and copy the code suggestion text in the source code editor window, or another GUI for later reference (e.g., a GUI of a word processor, spreadsheet, digital notetaking application, etc.), and the copying of the particular code suggestion may be interpreted by the project guidance engine as an indication that this code suggestion, and its underlying template, are of particular relevance to the project. This may cause, in some instances, for subsequent code suggestions to be drawn preferentially or exclusively from the corresponding template of the copied code suggestion. In yet another example, the project guidance engine, while monitoring code entered by the user in a source code editor window following presentation of the alternative code suggestions (e.g., 505a-c), may additionally detect that the user has adopted one of the alternative code suggestions (e.g., 505a-c) in the code subsequently entered through the source code editor window. Such may also be interpreted as a user's endorsement of a particular one (or subset) of templates, such that subsequent suggestion information offered for the project is also based on this template, among other examples.

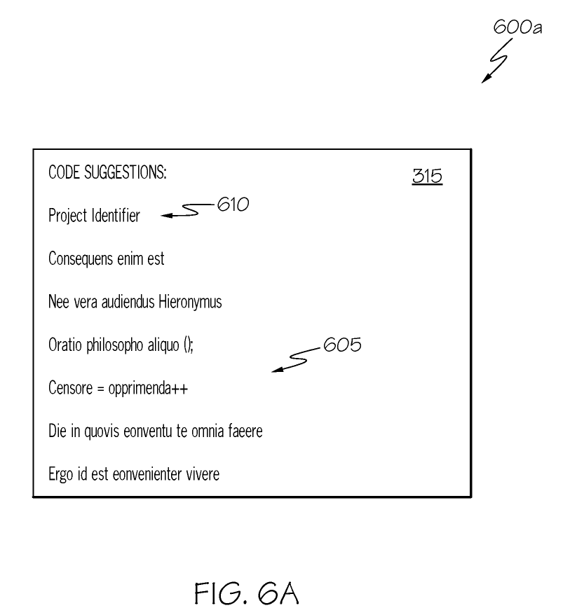

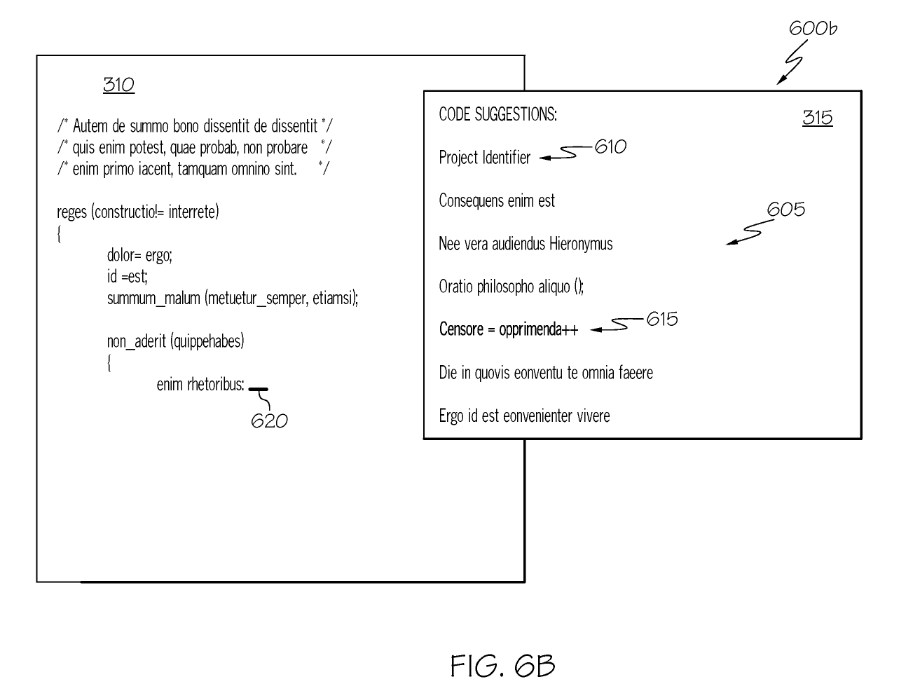

FIGS. 6A-6B illustrate additional examples 600a-b of suggestion information as it may be generated and presented in example suggestion windows of an enhanced software development system. In the example of FIG. 6A, as noted above, multiple suggestions may be presented for development of subsequent lines of code in a particular coding project (e.g., being developed contemporaneously by a developer using a corresponding source code editor) based on the same template. Such a presentation may be provided based on the selection of a single template for a coding project under development, such as when the project guidance engine determines that only a single one of the templates is relevant to the project (e.g., based on an analysis of the code within the project) or based on implicit or explicit feedback from the user that suggestions from a particular one of the template are of most use within the project, among other examples. In one example, a series of suggestions (e.g., 605) corresponding to the same type or class of coding project (modeled by the template) may be presented, the series of suggestions (e.g., 605) corresponding to an order or sequential pattern of coding steps observed within coding projects of this type or class. In this manner, a user may be presented with suggestions for multiple, subsequent lines of code, giving the user suggestions that go beyond just the next line of code and provide a higher level of view of the suggested work to be performed. Further, as lines of code are added by the user, indicating the user's progression through this sequence, additional suggestions may be provided and come into view within the guidance window to assist the user in appreciating the next lines of code or coding steps that follow in the sequence. Indeed, as shown in the example of FIG. 6B, a project guidance engine may determine where a user is in the suggested sequence of coding steps or lines of code based on monitoring the position of the cursor (e.g., 620) within the corresponding source code editor window 310. From this, the project guidance engine may cause suggestion information (e.g., 615) corresponding to the current or immediate next coding step within the sequence to be particularly identified within the guidance window 315. For instance, where a series of code suggestions are presented within the guidance window 315 from a same template (e.g., as may be indicated through an identifier (e.g., 610) presented corresponding to the series of code suggestions 605 in the guidance window 315), a particular one of the suggestions may be determined to be most relevant to the user based on the position of the user's cursor (e.g., 620) (or other user interactions with a corresponding software development system GUI), and the particular suggestion may be presented at the top of the set of suggestions, may be highlighted, presented in a different font, or otherwise presented differently from other suggestions to indicate this suggestion's more immediate importance, while still allowing other downstream coding suggestions (in the set) to remain visible for consideration by the developer.

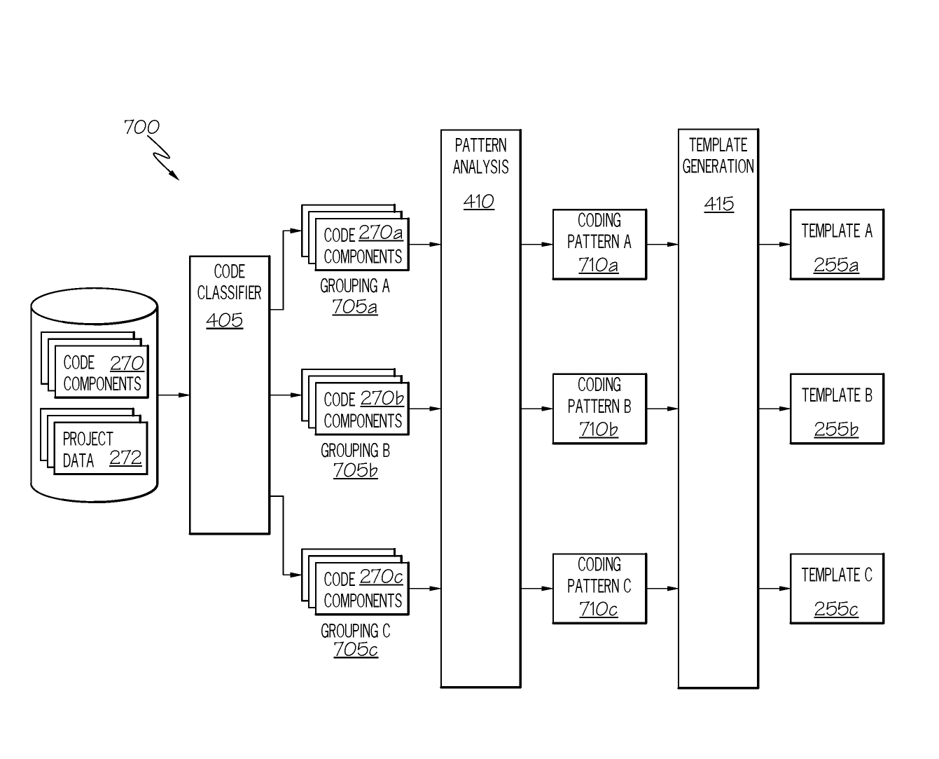

Turning to FIG. 7, a simplified block diagram 700 is shown illustrating generation of example code progression templates, as may be used by an example project guidance engine to generate and present code suggestion information for a particular coding project. In this example, a template generator (e.g., implemented as part of otherwise in association with an example project guidance engine) may analyze code within a corpus of code components (e.g., 270), as well as associated metadata (e.g., 272) describing other attributes of the code components, to determine similarities between the code components. These determined similarities may serve as the basis for generating code progression templates that may be employed in the future to guide developers attempting to develop projects, which include similar code and related functionality. In some implementations, a computing system implementing the template generator may operate autonomously to determine such similarities, as well as perform other processes to generate templates for use by a project guidance engine.

In the example of FIG. 7, code classification logic (e.g., implemented through machine learning models, specialized logic hardware, and/or software) may accept, as inputs, code (e.g., 270) and metadata (e.g., project data 272) corresponding to a variety of different code component within a corpus (e.g., hosted by a repository system). Based on or in connection with classifications determined by the template generator, the template generator may determine groupings of code 705a-c, each including a respective number of code components (e.g., 270a-c) from the corpus. Code within the respective groupings 705a-c of code components may be analyzed using pattern analysis logic 410, to determine corresponding patterns (e.g., 710a-c) within the code of these groupings 705a-c. Based on these determined patterns (e.g., 710a-c), corresponding templates 255a-c may be generated using template generation logic (e.g., 415), each template corresponding to a respective one of the determined classifications, or groupings (e.g., 705a-c). As noted above, the templates may be generated to include data as hints for use by a project guidance engine to determine whether code currently under development by a corresponding software development system is similar to one or more of the generated templates (e.g., 255a-c). In some implementations, a machine learning model may be trained to classify code (and/or project metadata) of a current project as pertaining to one or more of the generated templates (e.g., 255a-c), among other examples. A project guidance system may access the templates (e.g., 255a-c) to select a subset of the templates for use in generating code suggestion information for presentation in a guidance window based, for instance, on the pattern information (e.g., from 710a-c) encoded within the templates (e.g., 255a-c), among other example implementations.

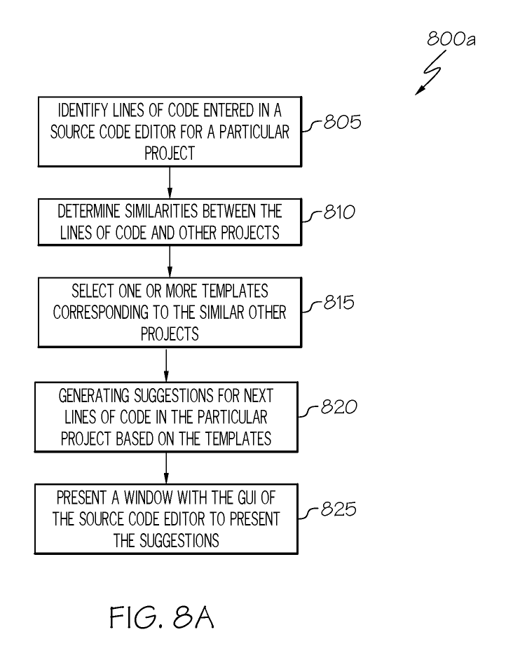

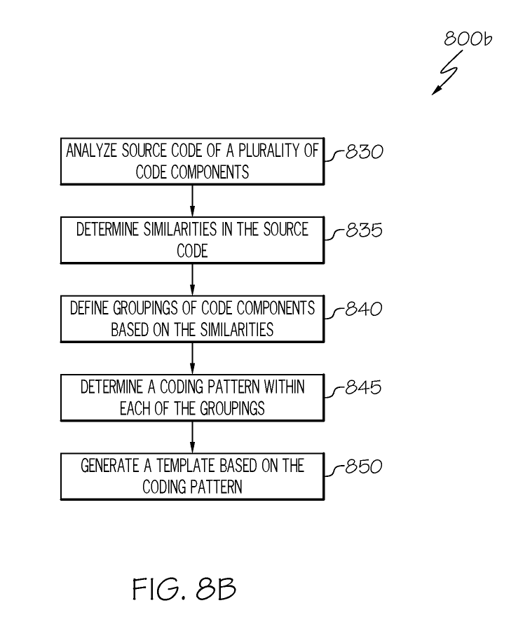

Turning to FIGS. 8A-8B, simplified flowcharts 800a-b are presented illustrating example techniques for providing coding guidance information for display to a user in connection with a user's use of a software development tool, such as a source code editor. For instance, in the example of FIG. 8A, lines of code may be identified 805, which have been entered in connection with a particular coding project by one or more users using an example source code editor. In connection with (e.g., contemporaneous with) the use of the source code editor to develop the particular coding project, a computing system may autonomously assess the lines of code to determine 810 similarities between the lines of code and other coding projects (e.g., developed by other users). One or more code progression templates may be selected 515 from a library of available templates, which correspond to the other coding projects determined to be similar to the lines of code of the particular coding project. The computing system may use the selected templates to autonomously generate code suggestions for the next lines of code in the particular project. The “next” lines may be based on a current position of a cursor within the code of the particular coding project using the source code editor, may be the temporally last-entered lines of code in the particular coding project, or may be the last lines of code within a file currently edited using the source code editor, among other examples. A guidance window may be presented with the GUI of the source code editor (e.g., in the same window or a separate window co-presented with the source code editor window) to present the code suggestions to the user and assist the user with understanding possible next lines of code that might be advantageously entered in the coding project, among other example advantages and uses.

Turning to the example of FIG. 8B, source code of multiple different code components (e.g., within multiple different coding projects) may analyzed 830 (e.g., using code parsing, natural language processing, machine learning models, etc.) to determine attributes of the code components. Similarities between some of the code components may thereby be determined 835 based at least partially on the code within the code components. Groupings of similar code components may be defined 840 based on similarities identified between code components in each grouping. Common or similar coding pattern (e.g., sequences of functional code, common lines of code or code structures, etc.) may be determined 845 within code components within each defined grouping. Respective code progression templates may be generated 850 based on these determined patterns such that the templates may be consumed by example project guidance engines to autonomously identify that one or more templates apply to particular code under development (as in the example of FIG. 8A) and generate code suggestions to be displayed in a GUI guidance window during the development of the particular code, among other example uses.

The flowcharts and block diagrams in the Figures illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

1. A method comprising:
identifying particular lines of code entered in a source code editor graphical user interface (GUI) in a particular coding project;
determining, using at least one data processing apparatus, similarities between the particular coding project and a subset of coding project templates in a plurality of coding project templates based on the particular lines of code, wherein the subset of coding project templates are based on a set of other coding projects, and the similarities are determined based at least in part on a correlation between the particular lines of code and lines of code in the set of other coding projects;
determining, using at least one data processing apparatus, suggestions, defined in the subset of code templates, for lines of code following the particular lines of code; and
presenting, using at least one data processing apparatus, a particular GUI window for display with the source code editor GUI, wherein the particular GUI window presents the suggestions.

2. The method of claim 1, further comprising:
identifying subsequent lines of code entered in the source code editor GUI for the particular coding project;
determining additional suggestions defined in the coding project templates corresponding to lines of code following the subsequent lines of code; and
adjusting presentation of the particular GUI window to display the additional suggestions based on entry of the subsequent lines of code in the source code editor GUI.

3. The method of claim 2, further comprising determining similarity of the particular coding project with another one of the coding project templates outside the subset the coding project templates based on the subsequent lines of code, wherein the additional suggestions are defined the other coding project template.

4. The method of claim 1, wherein the subset of coding project templates comprises two or more coding project templates, the suggestions comprise a plurality of suggestions, the plurality of suggestions comprise one or more suggestions defined in each one of the two or more coding project templates, and the method further comprises:
detecting that a particular one of the plurality of suggestions is adopted in subsequent code entered in the source code editor GUI within the particular coding project, wherein the particular suggestion is defined within a particular one of the two or more coding project templates; and
determining additional suggestions for presentation in the particular GUI window from the particular coding project template based on adoption of the particular suggestion in the particular coding project.

5. The method of claim 4, further comprising filtering out suggestions from at least one of the two or more coding project templates other than the particular coding project template based on adoption of the particular suggestion in the particular coding project.

6. The method of claim 1, wherein the suggestions comprise pseudocode corresponding to lines of code following the particular lines of code.

7. The method of claim 1, wherein the suggestions comprise a series of suggestions from a particular coding project template in the subset of coding project templates, and the series of suggestions comprise suggestions for a series lines of code following the particular lines of code, and the method further comprises:
detecting a cursor in the source code editor GUI positioned to correspond to one of the particular lines of code; and
automatically highlighting at least a particular one of the series of suggestions in the particular GUI window to indicate that the particular suggestion corresponds to a line of code to be entered following the one of the particular lines of code.

8. The method of claim 7, wherein changing positioning of the cursor within the particular lines of code causes highlighting of other suggestions in the series of suggestions to change to indicate a correspondence between lines of the particular lines of code selected by the cursor and respective suggestions in the series of suggestions.

9. The method of claim 1, wherein the source code editor (GUI) comprises a GUI of a source code editor in an integrated development environment (IDE).

10. The method of claim 1, wherein the other coding projects comprises source code components in a source code management repository.

11. The method of claim 1, further comprising:
determining attributes of the particular coding project; and
generating the suggestions to include values based on the attributes, wherein the values comprise values for inclusion in lines of code suggested by the suggestions.

12. The method of claim 1, further comprising:
predicting, using at least one data processing apparatus, intended functionality of the particular coding project, wherein at least one of the similarities comprises a similarity between the intended functionality and functionality of a particular one of the other coding project corresponding to a particular one of the subset of coding project templates.

13. The method of claim 12, wherein the intended functionality is predicted based on comments within the source code of the particular coding project.

14. The method of claim 1, further comprising generating one or more of the plurality of coding project templates.

15. The method of claim 14, wherein generating the plurality of coding projects comprises:
analyzing source code of the other coding projects to determine a plurality of groupings of coding projects, wherein each of the groupings of coding projects comprises a respective set of coding projects with similar source code;
detecting, for at least a particular one of groupings of coding projects, a pattern in source code of the coding projects within the particular grouping; and
generating a particular one of the coding project templates based on the pattern, wherein the particular coding project template comprises

16. The method of claim 15, wherein analyzing the source code comprises applying a machine learning model to determine that coding projects comprise source code similar to source code of other coding projects in the particular grouping.

17. A non-transitory computer readable medium having program instructions stored therein, wherein the program instructions are executable by a computer system to perform operations comprising:
detecting particular code entered in a graphical user interface (GUI) of a source code editor, wherein the particular code is entered in association with a particular coding project;
determining similarities between the particular code and one or more other coding projects;
determining one or more coding templates corresponding to the one or more other coding project;
determining, from the one or more coding templates, suggestions for next lines of code following the particular code in the particular coding project; and
causing the suggestions to presented in a GUI window presented with the GUI of the source code editor.

18. A system comprising:
a data processing apparatus;
a memory;
a source code editor to enable editing of code in a particular coding project, wherein the source code editor comprises a graphical user interface (GUI); and
an autonomous project guidance engine, executable by the data processing apparatus to:
detect particular code entered in the GUI of the source code editor, wherein the particular code is entered in association with the particular coding project;
determine similarities between the particular code and one or more other coding projects;
determine one or more coding templates corresponding to the one or more other coding project;
determine, from the one or more coding templates, suggestions for next lines of code following the particular code in the particular coding project; and
cause the suggestions to be presented in a GUI window presented with the GUI of the source code editor.

19. The system of claim 18, further comprising a repository system to manage a repository comprising the other coding projects.

20. The system of claim 18, further comprising a machine learning engine to determine the similarities using one or more machine learning models.
